(19) United States
(12) Patent Application Publication
(10) Pub. No.: US 2025/0377539 A1
(43) Pub. Date: Dec. 11, 2025

(54) HEAD-UP DISPLAY FOR A VEHICLE, AND VEHICLE

(71) Applicant: AUDI AG, Ingolstadt (DE)

(72) Inventor: Christian WALL, Hitzhofen (DE)

(21) Appl. No.: 19/229,733

(22) Filed: Jun. 5, 2025

(30) Foreign Application Priority Data
Jun. 11, 2024 (DE) 10 2024 116 329.1

(51) Int. Cl. G02B 27/01; B60K 35/23

(52) U.S. Cl. CPC G02B 27/0101; B60K 35/23; G02B 27/0149; B60K 2360/23; G02B 2027/0118; G02B 2027/0154

(57) ABSTRACT

A head-up display for a vehicle is disclosed, and may include a housing, a piece of image generating equipment arranged in the housing, an optical module arranged in the housing for projecting an image generated by the piece of image generating equipment, a mirror bank for absorbing light, and a glare trap arranged in a beam path of the image. The optical module may be configured to project the image through a housing opening to the housing. The glare trap may be configured to allow light of the image to pass through the glare trap and to reflect outside light in a direction of the housing to the mirror bank when the glare trap is in a use position. The glare trap may be formed from a deformable material. The glare trap may be convertible between the use position and a non-use position.

### BACKGROUND

### Technical Field

The disclosure relates to a head-up display for a vehicle, and a vehicle having a head-up display.

### Description of the Related Art

Head-up displays (“HUDs”) are being installed more and more frequently in modern vehicles, e.g., motor vehicles, but also rail vehicles and aircraft. The HUD is generally positioned in the cockpit in front of the driver in a designated installation space. A control panel (or dashboard) has an opening for this purpose in the area of an instrument cowl, which can be closed with a cover after the HUD is installed. Conventional optical elements such as mirrors, lenses, diffusers and displays are typically used for the optical design of the HUD. These elements are located in a sealed housing that has a thin cover glass (so-called glare trap) for the light emission. The glare trap directs sunlight entering from outside onto a so-called mirror bank and prevents unwanted reflections in the driver’s field of vision.

For example, DE10220180A1 describes a head-up display for a motor vehicle windscreen. A pivoting cover is arranged above an optical module of the head-up display, which, in a use position, serves to shield a driver from unwanted reflections. The cover can be designed in two parts.

CN103885183A discloses a cover for a so-called combiner head-up display of a motor vehicle. A combiner disk is extended from a housing, via which the image generated in the combiner HUD is reflected to a driver. Additionally, the combiner HUD has a cover consisting of three telescopically movable sub-segments to close the combiner HUD when not in use.

The required structural volume of a HUD increases with the size of the virtual image to be displayed and the virtual image distance. The size of a HUD is determined, among other things, by the available installation space in the control panel of a vehicle cockpit, and is limited. Installation and removal can only be performed through the limited opening in the control panel. The use of a conventional glare trap and mirror bank limits the size of a HUD in a vehicle.

### BRIEF SUMMARY

Against this background, the present disclosure provides a head-up display (“HUD”) for a vehicle that is compact, requires a smaller structural volume, and thus, not least, simplifies its installation in the vehicle. Furthermore, the head-up display should provide good image quality and contribute to a high level of driving safety.

It should be noted that the features listed individually in the claims can be combined with one another in any technically reasonable manner (even across category boundaries, for example, between method and device) and demonstrate further configurations of the present disclosure. The description further characterizes and specifies the present disclosure, particularly in conjunction with the figures.

It should also be noted that a conjunction “and/or” used herein, which stands between two features and links them together, is always to be interpreted in such a way that in a first configuration of the inventive subject matter only the first feature can be present, in a second configuration only the second feature can be present and in a third configuration both the first and the second feature can be present.

The subject matter of the present disclosure is a HUD for a vehicle, in particular a motor vehicle, which may have a housing, a piece of image generating equipment arranged in the housing, an optical module arranged in the housing for projecting an image generated by the piece of image generating equipment and to be projected through a housing opening outside the housing, a mirror bank for absorbing light, and a glare trap arranged in a beam path of the image to be projected. The so-called glare trap may be configured, in a use position, to allow light of the image to be projected from the housing to pass through and to reflect light incident in the direction of the housing to the mirror bank, which absorbs at least a large part of the incident light, e.g., 95% or completely. According to the present disclosure, the glare trap may be formed from a deformable material and may be convertible between the use position, in which the glare trap has a first average curvature unequal to zero, and a non-use position, in which the glare trap has a second average curvature that is smaller in magnitude than in the use position. The use position of the glare trap corresponds to a use state of the HUD, and the non-use position corresponds to a non-use state of the HUD.

In other words, the HUD may not have a fixed, rigid glare trap, as is the case with a conventional cover glass, for example. The glare trap may prevent light incident from the outside, such as sunlight, streetlights, or similar, into the vehicle or the HUD housing, from causing reflections that may significantly interfere with a driver’s view of the image and even endanger driving safety.

In order to reliably reflect light incident from the outside from different directions to the mirror bank, the glare trap may have, in the use position, an average curvature unequal to zero, i.e., a bulging. The bulging may not necessarily have a constant radius of curvature across the entire surface of the glare trap, so that, according to the disclosure, an average curvature is considered, which can be understood to mean an average value of different radii of curvature that describe the curvature or bulging of the entire optically active surface of the glare trap.

According to the present disclosure, the glare trap may have, in the non-use position, an average curvature that is smaller in magnitude than in the use position. In other words, the glare trap may be flatter in the non-use position than in the use position. A cuboid enclosing the glare trap may thus have a smaller volume in the non-use position than in the use position.

For the purposes of the present disclosure, the relative terms “smaller” and “flatter” used herein to refer to the curvature of the glare trap are to be interpreted such that manufacturing-related size deviations of the feature in question, which are within the manufacturing tolerances defined for the production of the glare trap, are not covered by the respective relative term. In other words, the curvature of the glare trap is only to be considered “smaller” or “flatter” than that of the comparison feature if the two compared variables differ so significantly in value that this size difference certainly does not fall within the manufacturing-related tolerance range of the feature in question, but is the result of deliberate action.

The deformability of the glare trap may enable a compact design of the head-up display, making it easier to integrate into a vehicle’s control panel or dashboard. Furthermore, in the non-use state, the HUD’s small structural volume may simplify installation into the control panel or dashboard. Conversely, the head-up display according to the present disclosure may be used to provide large-format augmented reality head-up displays (“AR HUDs”) within a given structural volume.

In addition to reducing the volume of the HUD in the non-use state, a housing height may be reduced in the non-use state due to the flatter glare trap geometry.

When the head-up display is installed in the vehicle, the image to be projected outside the housing may be projected onto a projection surface, which may be a pane of the vehicle (e.g., windscreen or windshield), and reflected by the pane so that the projected image may be seen by a driver.

The optical module may have optical elements, such as mirrors, lenses, diffusers, or similar, which are suitable for influencing the beam path of the image to be projected from the piece of image generating equipment to the projection surface as desired.

In some embodiments, the glare trap may be flat in the non-use position. In other words, the glare trap may have, in the non-use position, substantially no bulging, i.e., the average curvature is zero, but rather runs substantially parallel to a uniformly flat surface, which may, for example, be the surface containing the housing opening. Such embodiments enable the glare trap geometry to be lowered to its maximum in the non-use position.

In some embodiments, the glare trap may be formed from a flexible film. The film may be converted into the desired shape of the use and non-use position. The film may be configured such that the film is transparent to the image to be projected, but reflects ambient light, such as sunlight, streetlights, or similar, to deflect the ambient light toward the mirror bank.

In some embodiments, the glare trap may be held stationary on the housing at a first section and may be raised relative to at least part of the housing at a diametrically opposite second section via a curved track. For example, when the HUD is installed in a vehicle, the first section may correspond to a front section of the glare trap and the second section may correspond to a rear section of the glare trap, as seen in the direction of travel of the vehicle. Using appropriately designed kinematics, the rear section of the glare trap may be raised relative to the front section via the curved track. After being raised to an end position, the glare trap may form a bulged surface and may be used for optical anti-reflection.

Raising the second section of the glare trap may be implemented, for example, by two interconnected housing parts, one of which may be mounted on the other to be pivotable about a pivot axis, and the first section of the glare trap may be held stationary in the area of the pivot axis, and the second section of the glare trap may be held on the pivotable housing part. Accordingly, the second section of the glare trap may be raised relative to the other housing part when the housing part is pivoted into the use position.

In some embodiments, the mirror bank may be movably held on the housing, closing the housing opening in the non-use position of the glare trap, and clearing the beam path of the image to be projected in the use position of the glare trap. In other words, the HUD may not have a fixed mirror bank. Instead, the HUD may be configured as a kinematically movable (optionally multi-part) cover. Thus, the mirror bank may not only be used to absorb light when the glare trap is in the use position, but may also enable the HUD to appear closed when in the non-use state. In the closed position, i.e., the position closing the housing opening, the HUD may preferably be tightly sealed and the mirror bank may form a flush connection to a control panel in which the HUD is installed. The mirror bank may be optically opaque and thus may offer, in the non-use state, very good protection against heating of the components accommodated in the housing (e.g., piece of image generating equipment, optical elements of the optics module, electronics, and the like) due to external light (e.g., sunlight).

In the position of the mirror bank closing the housing opening, the glare trap may preferably be arranged between the mirror bank and the housing, so that the glare trap, in the non-use position, is covered and protected by the mirror bank. For example, the glare trap may be arranged in the housing opening.

In yet further embodiments, the mirror bank may have a plurality of flexibly interconnected sub-segments which may be arranged to form a flat surface in the position closing the housing opening and may be folded in the position clearing the beam path. For example, the sub-segments may be pivotally connected to adjacent sub-segments such that the sub-segments are compactly folded together in the position clearing the beam path. In the position closing the housing opening, the sub-segments may form a flat surface which may preferably run substantially parallel to the plane of the housing opening.

Large-format AR HUDs, in particular, may require a large cover. Therefore, it may be advantageous to divide the mirror bank, which may serve as a cover for the housing opening, into multiple sections. For example, the mirror bank may comprise three sub-segments. To save installation space and keep kinematics simple, the sub-segments may be moved toward the windshield when the HUD is installed in the vehicle, where the sub-segments may form the mirror bank. Extending the glare trap into the use position may ensure the anti-reflective function of the glare trap mirror bank arrangement. The mirror bank may be configured such that the sub-segments do not cut off the optical system, i.e., the beam path of the image to be projected.

In further embodiments, in the position of the mirror bank clearing the beam path, at least one of the sub-segments may provide a light absorption surface onto which the light reflected by the glare trap strikes and is absorbed. The light absorption surface may preferably correspond to a broad side of the sub-segment. The mirror bank, or at least the sub-segment providing the absorption surface, may be made of a matte black material or coated with a matte black, light-absorbing paint. The absorption surface may be configured to absorb a high proportion of the incident light, for example, 95% or more. For example, the mirror bank may have several plastic panels as sub-segments.

Furthermore, the present disclosure is directed to a vehicle, in particular a motor vehicle, having a head-up display which is designed according to any one of the embodiments disclosed herein.

It should be understood that with regard to vehicle-related definitions of terms as well as the effects and advantages of vehicle-specific features, the disclosure of corresponding definitions, effects, and advantages of the head-up display according to the present disclosure can be fully referred to, and vice versa. Repetition of explanations of similar features, their effects, and advantages can thus be omitted in favor of a more concise description, without such omissions being interpreted as a limitation of any of the disclosed subject matter of the present disclosure.

### BRIEF DESCRIPTION OF THE SEVERAL VIEWS OF THE DRAWINGS

FIG. 1 shows a sectional side view of a head-up display and a vehicle according to an embodiment of the present disclosure in a non-use state of the head-up display.

FIG. 2 shows a sectional side view of the head-up display and the vehicle of FIG. 1 in a use state of the head-up display.

### DETAILED DESCRIPTION

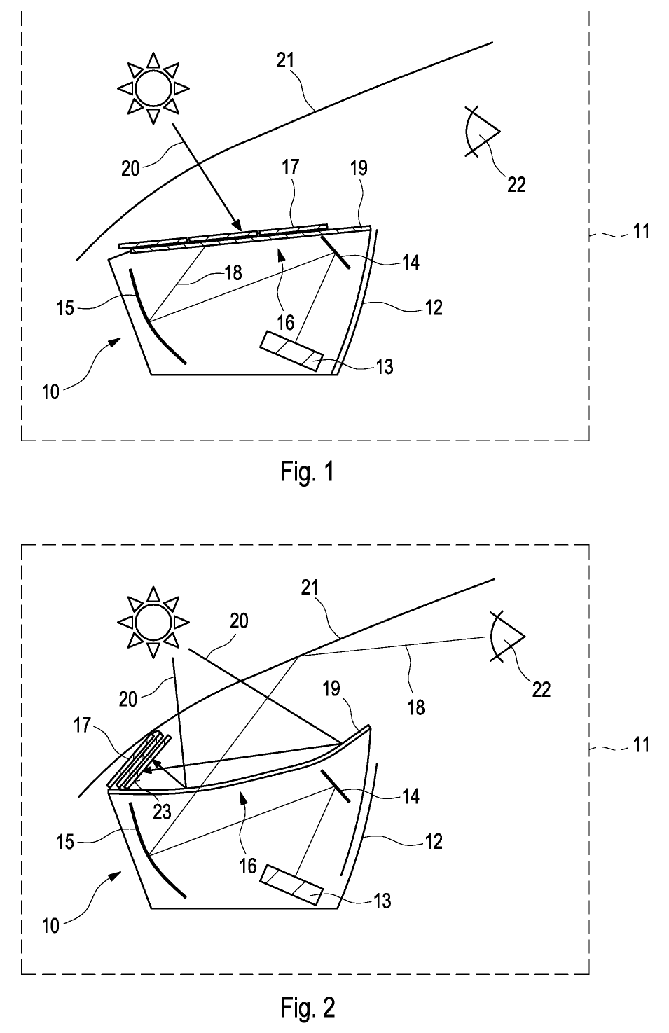

FIG. 1 shows schematically a sectional side view of a head-up display (HUD) 10 and a vehicle 11, e.g., a motor vehicle, rail vehicle, or aircraft, according to an embodiment of the present disclosure, in a non-use state of the head-up display 10. In the embodiment shown in Figure 1, HUD 10 is installed, by way of example, in a motor vehicle 11, but is not necessarily limited to motor vehicles. FIG. 2 shows head-up display 10 and vehicle 11 from FIG. 1 in a use state of head-up display 10. Reference is made alternately to both FIGS. 1 and 2 below.

Head-up display 10 may have a housing 12, a piece of image generating equipment 13 (e.g., an LED display) arranged in housing 12, an optical module arranged in housing 12, which in this embodiment shown in the figures has a folding mirror 14 and an aspherical mirror 15 for projecting an image generated by the piece of image generating equipment 13 and to be projected through a housing opening 16 outside the housing 12, a mirror bank 17 for absorbing light, and a glare trap 19 arranged in a beam path 18 of the image to be projected. Glare trap 19 may be configured, in a use position shown in FIG. 2, to allow light of the image to be projected from housing 12 to pass through and to reflect light 20 (e.g., sunlight, street lighting, or the like) incident in the direction of housing 12 to mirror bank 17. Glare trap 19 may be formed from a deformable material, e.g., a flexible film, and may be convertible between the use position (FIG. 2), in which the glare trap 19 may have a first average curvature unequal to zero, and the non-use position (Figure 1), in which the glare trap 19 may have a second average curvature that is smaller in magnitude than in the use position. Appropriate kinematics (not shown in detail) may be provided for this purpose.

From FIG. 1 it can be seen that glare trap 19 of the exemplary embodiment of HUD 10 may be flat in the non-use position and, in contrast to the use position shown in FIG. 2, may have substantially no bulging, i.e., its average curvature is zero. Furthermore, it can be seen from FIG. 1 that glare trap 19, in the example shown, may be arranged between mirror bank 17 and housing 12. Glare trap 19 may be arranged, for example, in housing opening 16, but is not necessarily limited thereto.

As can be further seen in FIGS. 1 and 2, the image to be projected outside housing 12, in the state installed in vehicle 11, may be projected onto a projection surface, which in the embodiment shown in the figures is a window pane 21, in particular a windscreen, of vehicle 11. The projected image may be reflected by said windscreen so that the projected image may be seen by a symbolically represented vehicle driver 22 (cf. beam path 18 in FIG. 2).

Without necessarily being limited thereto, glare trap 19 in the presently shown exemplary embodiment of HUD 10 may be held stationary on housing 12 at a first section. The first section may correspond to a front section viewed in the direction of a vehicle front of vehicle 11, i.e., a section facing windscreen 21. At a diametrically opposite second section of glare trap 19, i.e., in the embodiment shown in the figures, a rear section facing away from windscreen 21, said glare trap may be raised via a curved path relative to at least a part of housing 12 by way of kinematics not shown in detail. After being raised to a final position, which is reached in FIG. 2, glare trap 19 may form the bulged surface described herein, with which the optical anti-reflection may be implemented, which is shown in FIG. 2 by the reflection shown of light 20 incident from outside onto glare trap 19 in the direction of mirror bank 17, by which the light 20 may be absorbed.

Mirror bank 17 of HUD 10 may be movably held on housing 12. From FIG. 1 it can be seen that mirror bank 17 may close housing opening 16 when glare trap 19 is in the non-use position. Mirror bank 17 may enable a closed appearance of HUD 10 in the non-use state. In this closed position, HUD 10 may preferably be tightly sealed, and mirror bank 17 may form a flush connection to the control panel (not shown) in which HUD 10 is installed in vehicle 11.

As can be seen from FIG. 2, mirror bank 17 may completely clear beam path 18 of the image to be projected in the use position of glare trap 19.

In the exemplary embodiment shown in FIGS. 1 and 2, mirror bank 17 may have a plurality of flexibly interconnected sub-segments, in this case three sub-segments, which may be arranged to form a flat surface in the position of FIG. 1 closing housing opening 16 and may be folded in the position of FIG. 2 clearing beam path 18. It should be understood that the number of sub-segments is not necessarily limited to three. Mirror bank 17 may have more or fewer than three sub-segments.

In the present case, the respective sub-segments may be pivotally connected to adjacent sub-segments so that the sub-segments may be compactly pushed together in the position clearing beam path 18. Instead of a pivotable connection, e.g., implemented by way of hinges, the sub-segments may alternatively be formed from a flexible, foldable material that does not require hinges to push mirror bank 17 together into the folded configuration. In any case, when mirror bank 17 is moved toward windscreen 21, the sub-segments of mirror bank 17 may preferably position themselves so that at least one of the sub-segments forms a non-zero angle with the plane of housing opening 16, as can be seen in FIG. 2. In this way, the rear sub-segment of the mirror bank 17 in the present case may provide a light absorption surface 23 which the light reflected by glare trap 19 strikes and is absorbed.

German patent application no. 102024116329.1, filed June 11, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A head-up display for a vehicle, comprising:
a housing;
a piece of image generating equipment arranged in the housing;
an optical module arranged in the housing for projecting an image generated by the piece of image generating equipment, the optical module configured to project the image through a housing opening to outside the housing;
a mirror bank for absorbing light; and
a glare trap arranged in a beam path of the image, the glare trap configured to allow light of the image to pass through the glare trap and to reflect outside light in a direction of the housing to the mirror bank when the glare trap is in a use position,
wherein the glare trap is formed from a deformable material,
wherein the glare trap is convertible between the use position, and a non-use position,
wherein in the use position, the glare trap has a first average curvature unequal to zero, and
wherein in the non-use position, the glare trap has a second average curvature that is smaller in magnitude than in the use position.

2. The head-up display according to claim 1, wherein the glare trap is flat in the non-use position.

3. The head-up display according to claim 1, wherein the glare trap is formed from a flexible film.

4. The head-up display according to claim 1, wherein the glare trap is configured to be held stationary on the housing at a first section and to be raised relative to at least a part of the housing at a second section via a curved track, wherein the second section is diametrically opposed to the first section.

5. The head-up display according to claim 1, wherein the mirror bank is movably held on the housing, such that the mirror bank closes the housing opening when the glare trap is in the
non-use position, and such that the mirror bank clears the beam path of the image when the glare trap is in the use position.

6. The head-up display according to claim 5, wherein the mirror bank has a plurality of flexibly interconnected sub-segments configured to be arranged to form a flat surface to close the housing opening and to be folded to clear the beam path.

7. The head-up display according to claim 6, wherein when the mirror bank clears the beam path, at least one of the sub-segments provides a light absorption surface configured such that the light reflected by the glare trap strikes the light absorption surface and is absorbed.

8. The head-up display according to claim 1, wherein the glare trap is arranged in the housing opening.

9. The head-up display according to claim 1, wherein the vehicle is a motor vehicle.

10. A vehicle, comprising:
a head-up display including:
a housing;
a piece of image generating equipment arranged in the housing;
an optical module arranged in the housing for projecting an image generated by the piece of image generating equipment, the optical module configured to project the image through a housing opening to outside the housing;
a mirror bank for absorbing light; and
a glare trap arranged in a beam path of the image, the glare trap configured to allow light of the image to pass through the glare trap and to reflect outside light in a direction of the housing to the mirror bank when the glare trap is in a use position,
wherein the glare trap is formed from a deformable material,
wherein the glare trap is convertible between the use position, and a non-use position,
wherein in the use position, the glare trap has a first average curvature unequal to zero, and wherein in the non-use position, the glare trap has a second average curvature that is smaller in magnitude than in the use position.

11. The vehicle according to claim 10, wherein the vehicle is a motor vehicle.
